(19) United States
(12) Patent Application Publication
(10) Pub. No.: US 2025/0030637 A1
(43) Pub. Date: Jan. 23, 2025

(54) NETWORK SCHEDULER IN A DISTRIBUTED STORAGE SYSTEM

(71) Applicant: VMware LLC, Palo Alto, CA (US)

(72) Inventors: Yiqi XU, Redwood City, CA (US); Eric KNAUFT, San Francisco, CA (US); Enning XIANG, San Jose, CA (US)

(21) Appl. No.: 18/224,970

(22) Filed: Jul. 21, 2023

(51) Int. Cl. H04L 47/12; H04L 47/2408; H04L 47/52

(52) U.S. Cl. CPC H04L 47/12; H04L 47/2408; H04L 47/52

(57) ABSTRACT

Aspects of the disclosure perform network scheduling in a distributed storage system. Example operations include: determining a network congestion condition at a first host; based on the network congestion condition, determining a packet delay time; based on a first data packet belonging to a first traffic class of a plurality of traffic classes, delaying transmitting the first data packet, from the first host across a network to a second host, by the packet delay time; and based on a second data packet belonging to a second traffic class, transmitting the second data packet from the first host to the second host without a delay. In some examples, the first traffic class comprises resync input/output operations (I/Os) and the second traffic class comprises non-resync traffic I/Os. Some examples delay packets differently, based on the destination host. Some examples adjust delays to drive the network congestion condition toward a target.

### BACKGROUND

In a virtual storage area network, which is a distributed storage system, a storage host may have a larger input/output (I/O) bandwidth than does the network, creating a data traffic bottleneck at the network used for routing the data among the different hosts/nodes. Further, there are multiple types of data traffic, some of which may be more aggressive than others in consuming available bandwidth. An example of typically aggressive data traffic is resync I/O operations (I/Os), which include data traffic related to tasks such as recovery operations (e.g., host rebuilding) and migrations.

Allowing aggressive data traffic to grow unchecked, as a percentage of total bandwidth demand on a network, curtails system performance that depends upon other types of data traffic, such as virtual machine (VM) I/Os, metadata traffic, and namespace traffic. For example, availability metrics may suffer when VM I/Os are delayed due to excessive resync I/Os.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for network scheduling in a distributed storage system. Examples include: determining a network congestion condition at a first host; based on at least the network congestion condition, determining a packet delay time; based on at least a first data packet belonging to a first traffic class of a plurality of traffic classes, delaying transmitting the first data packet, from the first host across a network to a second host, by the packet delay time; and based on at least a second data packet belonging to a second traffic class, transmitting the second data packet from the first host to the second host without a delay. In some examples, the first traffic class comprises resync input/output operations (I/Os) and the second traffic class comprises non-resync traffic I/Os. Some examples delay packets differently, based on the destination host. Some examples adjust delays to drive the network congestion condition toward a target.

### BRIEF DESCRIPTION OF THE DRAWINGS

The present description will be better understood from the following detailed description read in the light of the accompanying drawings, wherein:

FIG. 1 illustrates an example architecture that advantageously provides network scheduling in a distributed storage system;

FIG. 2 illustrates further detail for an example of an architecture that may be used;

FIG. 3 illustrates further detail for a component of the example architecture of FIG. 1;

FIG. 4 illustrates examples of data traffic that may occur within an example architecture, such as that of FIG. 1;

FIG. 5 illustrates examples of congestion categories that may be used within an example architecture, such as that of FIG. 1;

FIG. 6 illustrates an exemplary framework for measurement of network congestion as may occur when using an example architecture, such as that of FIG. 1;

FIG. 7 illustrates an example timeline for latency measurements as may occur with the example framework of FIG. 6;

FIG. 8 illustrates exemplary bandwidth utilization as a function of time, as may occur when using an example architecture, such as that of FIG. 1;

FIG. 9 illustrates a flowchart of exemplary operations associated with an example architecture, such as that of FIG. 1;

FIG. 10 illustrates an additional flowchart of exemplary operations associated with an example architecture, such as that of FIG. 1; and

FIG. 11 illustrates a block diagram of an example computing apparatus that may be used as a component of an example architecture such as that of FIG. 1.

Any of the figures may be combined into a single example or embodiment.

### DETAILED DESCRIPTION

Aspects of the disclosure provide solutions for network scheduling in a distributed storage system. Examples include determining a network congestion condition at a first host. Based on at least the network congestion condition, a packet delay time is determined. Based on at least a first data packet belonging to a first traffic class of a plurality of traffic classes, delaying transmission, by the packet delay time, of the first data packet from the first host across a network to a second host. Based on at least a second data packet belonging to a second traffic class, the second data packet is transmitted without a delay from the first host to the second host. In some examples, the first traffic class comprises resync input/output operations (I/Os) and the second traffic class comprises non-resync traffic I/Os. Some examples delay packets differently, based on the destination host. Some examples adjust delays to drive the network congestion condition toward a target.

Aspects of the disclosure are able to improve performance of computing operations by selectively throttling aggressive data traffic, such as resync traffic. This permits maintaining a given level of performance with fewer computing hardware resources or—with the same amount of computing hardware resources-achieving higher total performance. This advantageous operation is achieved, at least in part, by based on at least the first network congestion condition, determining a first packet delay time, and based on at least a first data packet belonging to a first traffic class of a plurality of traffic classes, delaying transmitting the first data packet, from the first host across a network to a second host, by the first packet delay time. Thus, because aggressive data traffic may choke other types of data traffic, resulting in performance degradation, aspects of the disclosure provide a practical, useful result to solve a technical problem in the domain of computing. Further, the operations described herein improve the functioning of the underlying computing device by improved management of network bandwidth, which also improves management of processing and storage.

Fairness measures are used in network engineering to determine whether different traffic classes and types are each receiving a fair share of resources. Congestion control mechanisms for network transmission protocols attempt to implement fairness by ensuring that no traffic class or type receives an excessive share of network bandwidth. An end-to-end fairness guaranteed system ensures that bottlenecks are fair, but at the cost requiring a comprehensive view of traffic congestion across the nodes and network. Although aspects of the disclosure may not provide end-to-end fairness guarantee, the disclosed distributed local congestion determinations at the various hosts does provide improved fairness without the costs of making a comprehensive network-wide congestion determination. This is advantageous due to the cost of making a comprehensive determination across a distributed architecture.

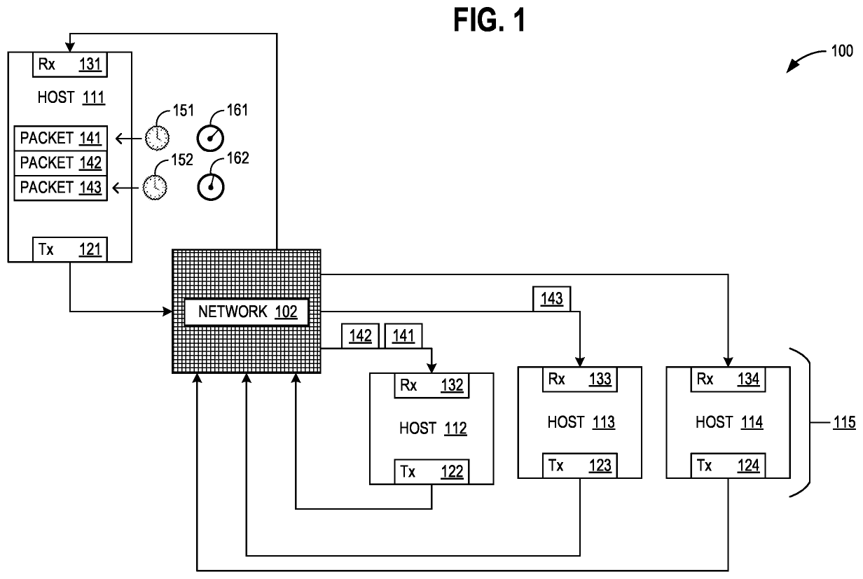

FIG. 1 illustrates an example architecture 100 that advantageously provides network scheduling in a distributed storage system. Architecture 100 uses a distributed storage system in which a network 102 routes data traffic among a plurality of hosts 115 comprising a host 111, a host 112, a host 113, and a host 114. Although only four hosts are shown, it should be understood that other examples may use a different number of hosts, such as numbering in the tens of thousands or more.

Host 111 has a transmitter (Tx) 121 to transmit data packets to other hosts through network 102 and a receiver (Rx) 131 to receive data packets from other hosts through network 102. Similarly, host 112 has a transmitter 122 and a receiver 132, host 113 has a transmitter 123 and a receiver 133, and host 114 has a transmitter 124 and a receiver 134.

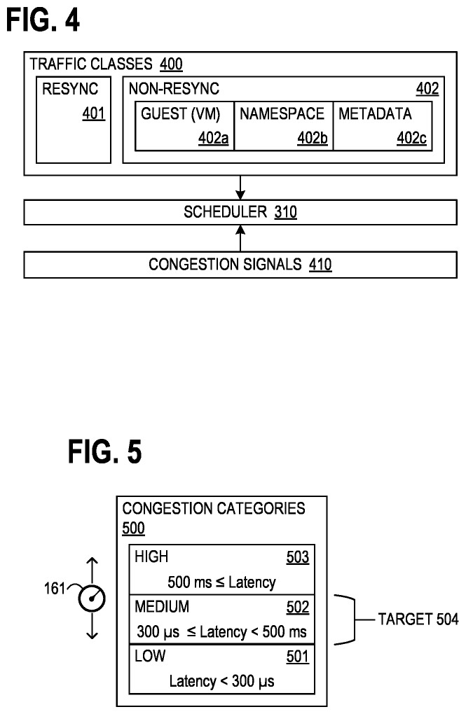

As illustrated, host 111 transmits a data packet 141 and a data packet 142 to host 112 and a data packet 143 to host 113. Although only three data packets are shown originating from one host, it should be understood that other examples may use a different number of data packets, such as numbering in the millions or more, transmitted from multiple hosts. Data packets 141 and 143 belong to an aggressive traffic class, such as resync I/Os, that aggressively consumes network bandwidth, while data packet 142 belongs to another, less-aggressive traffic class, such as non-resync I/Os. Traffic classes are described in further detail later, in relation to FIG. 4.

Because data packets 141 and 143 belong to an aggressive traffic class, they are subject to throttling as described in further detail, below. That is, the transmission of data packet 141 to host 112 is delayed by a packet delay time 151. During packet delay time 151, data packet 141 is held within host 111, and sent to network 102 upon the lapse of packet delay time 151. Packet delay time 151 is set based upon, at least partially, a network congestion condition 161. Similarly, the transmission of data packet 143 to host 113 is delayed by a packet delay time 152. During packet delay time 152, data packet 143 is held within host 111, and sent to network 102 upon the lapse of packet delay time 152. Packet delay time 152 is set based upon, at least partially, a network congestion condition 162.

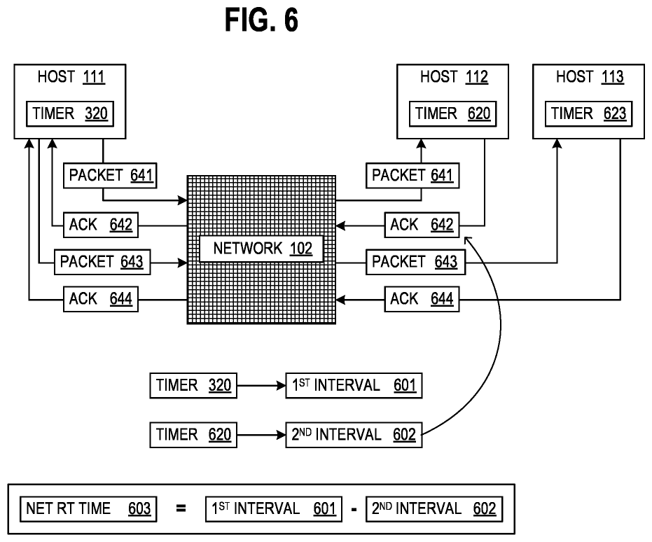

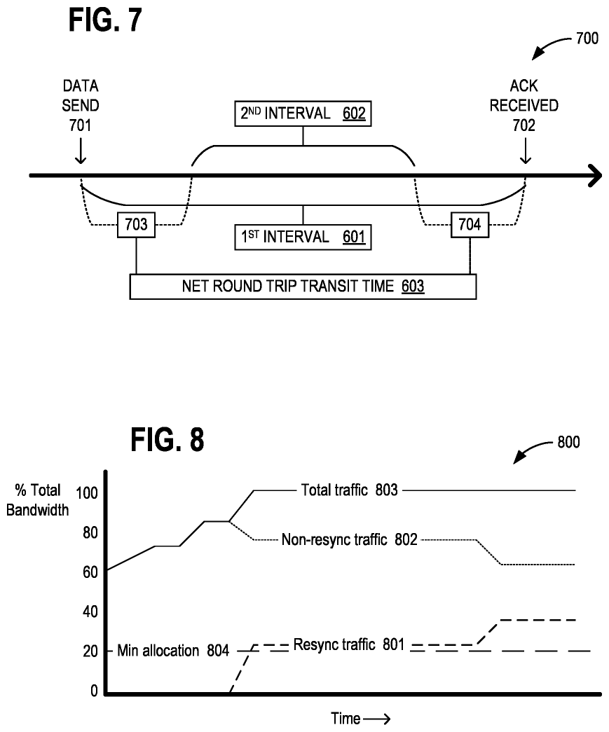

In some examples, network congestion condition 161 is specific to host 112 and network congestion condition 162 is specific to host 113. In such examples, packet delay time 151 may differ from packet delay time 152, with each being custom to their respective host's network congestion condition. In some examples, however, packet delay times 151 and 152 may be the same. In some scenarios, this may occur is only a single network congestion condition (e.g., network congestion condition 161) is measured for network congestion as seen by host 111 through network 102 for all hosts or some group of hosts. Determination of network congestion conditions is described in further detail in relation to FIGS. 6 and 7.

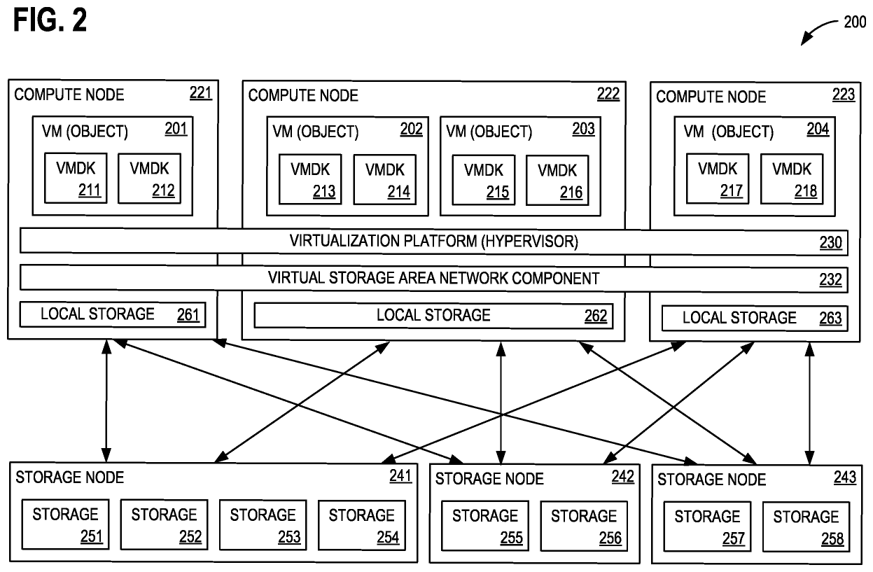

Examples of architecture 100 are operable with virtualized and non-virtualized storage solutions. FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

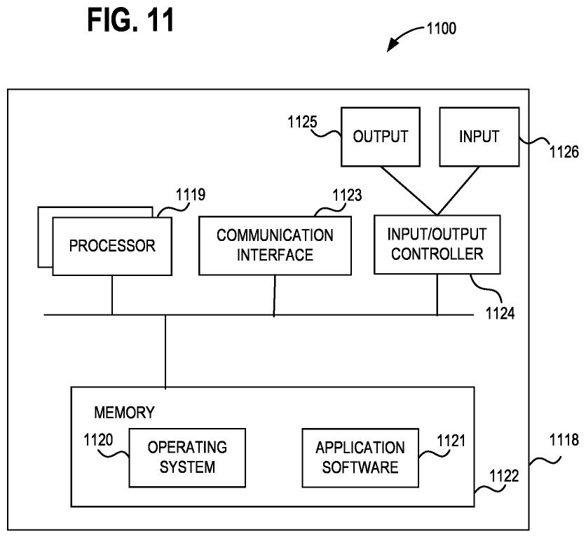

When objects are created, they may be designated as global or local, and the designation is stored in an attribute. For example, compute node 221 hosts object 201, compute node 222 hosts objects 202 and 203, and compute node 223 hosts object 204. Some of objects 201-204 may be local objects. In some examples, a single compute node may host 50, 100, or a different number of objects. Each object uses a VMDK, for example VMDKs 211-218 for each of objects 201-204, respectively. Other implementations using different formats are also possible. A virtualization platform 230, which includes hypervisor functionality at one or more of compute nodes 221, 222, and 223, manages objects 201-204. In some examples, various components of virtualization architecture 200, for example compute nodes 221, 222, and 223, and storage nodes 241, 242, and 243 are implemented using one or more computing apparatus such as computing apparatus 1118 of FIG. 11.

Virtualization software that provides software-defined storage (SDS), by pooling storage nodes across a cluster, creates a distributed, shared datastore, for example a SAN. Thus, objects 201-204 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 252, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-204 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201-204. Virtual SAN component 232 permits objects 201-204 to write incoming data from object 201-204 to storage nodes 241, 242, and/or 243, in part, by virtualizing the physical storage components of the storage nodes.

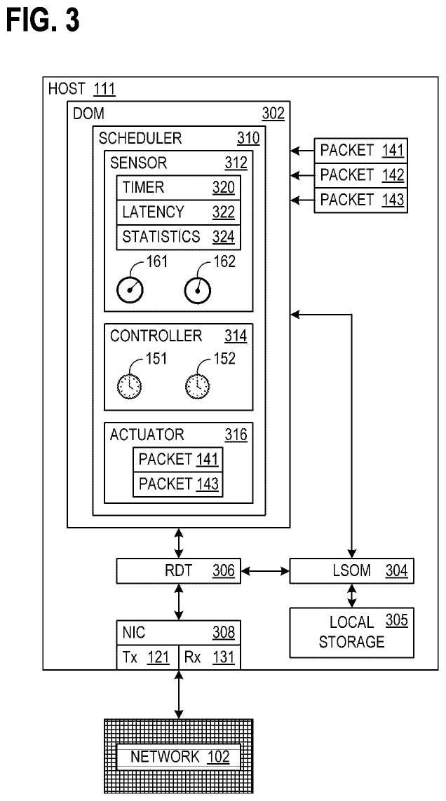

In general, any of hosts 111-114 of architecture 100 may be any of objects 201-204. FIG. 3 illustrates further detail for host 111, and which may also be considered to be representative for other hosts 112-114. Host 111 has an object manager, such as a distributed object manager (DOM) 302 and/or a local log structured object manager (LSOM) 304. Host 111 further has a local storage 305, a reliable data transport (RDT) layer 306, and a network interface controller (NIC) 308. While FIG. 3 is illustrated with DOM 302 and LSOM 304 for convenience, host 111 may have any form of object manager and the operations described herein are operable with any form of object manager.

DOM 302 is responsible for handling object availability (e.g., creation and distribution) and initial I/O requests. After a DOM object is created, one of the nodes (hosts) is selected as the DOM owner for that object and handles all I/Os for that DOM object by locating the respective child components across the cluster and redirecting the I/Os as necessary. In some examples there is a single DOM client per host (e.g., hosts 111-114 each have a single version of DOM 302). LSOM 304 manages local storage 305, for example providing read caching, write buffering, and any encryption operations for locally stored data on local storage 305. LSOM 304 handles local I/Os for DOM 302. For I/Os involving other hosts, DOM 302 sends data packets to (and receives data packets from) RDT layer 306.

RDT layer 306 is a software layer above NIC 308, and provides the protocol used for communication between hosts (e.g., between host 111 and other hosts 112-114). In some examples, RDT layer 306 uses transmission control protocol (TCP) and is responsible for creating and destroying TCP connections (sockets). In some examples, RDT layer 306 does not recognize the traffic classes of data packets 141-143, and is thus unable to selectively throttle traffic based on traffic class. NIC 308 has transmitter 121 and receiver 131, and provides the interface with network 102 for host 111.

A scheduler 310 provides throttling, such as class-dependent throttling. That is, scheduler 310 determines network congestion conditions 161 and 162 and delays transmitting outgoing data packets 141 and 143 by packet delay times 151 and 152. In some examples, scheduler 310 throttles fewer than all classes of traffic, for example one or two classes of traffic, such as resync I/Os. In some examples, scheduler 310 is located within DOM 302 or between DOM 302 and RDT layer 306. In the illustrated example, scheduler 310 has three components, a sensor 312, a controller 314, and an actuator 316. In some examples, the functionality described for these components of scheduler 310 may instead be allocated differently for alternative configurations.

In some examples, scheduler 310 works with one or more versions of a virtual storage area network (vSAN). In some examples, writes and reads are handled symmetrically such that data sends (writes) and data fetches (reads) are handled the same for delays. In some examples, scheduler 310 is a single-hop scheduler. In some examples, scheduler 310 throttles only, or primarily, data traffic between a DOM owner and component manager, because such traffic is the majority of intra-site data traffic.

Scheduler 310 shapes network traffic on the transmission side, re-ordering traffic according to packet delay times to improve fairness. Any type of traffic, such as writes at a DOM owner (with a payload), reads at a DOM component manager (with a payload), a write response at a DOM component manager (no payload), and a read request at a DOM owner (no payload), may be throttled. That is, traffic with and without payloads may be throttled. I/Os without payloads are delayed according to the amount of data expected to be sent (write response), or received (read request). Data traffic at layers below scheduler 310 is handled as a black box. As described below, I/Os that are throttled at the component side works as an aid in correcting the effect of averaging the latency statistics across all hosts with uneven distribution of IO traffic.

Sensor 312 determines latency (see FIGS. 6 and 7), which may include averaging latencies from multiple hosts, possibly using a rolling average (e.g., with more recently-reported latency having a higher weight). Sensor 312 has a timer 320 that is used for latency measurements. Calculated (e.g., averaged) latency 322 is placed into a data structure identified as statistics 324. Statistics 324 provides indications of network congestion conditions, such as network congestion conditions 161 and 162. In some examples, network congestion conditions (e.g., network congestion conditions 161 and 162) are updated on the order of 100 milliseconds (ms).

Controller 314 processes statistics 324 to determine packet delay times, such as packet delay times 151 and 152. These are the delay times before data packets that are subject to throttling (e.g., data packets 141 and 143) are sent to RDT layer 306, in order to achieve the desired throughput. In some examples, packet delay times (e.g., packet delay times 151 and 152) are updated on the same cadence as network congestion conditions.

Actuator 316 holds outgoing data packets according to the packet delay times determined by controller 314. For example, as data packets 141, 142, and 143 are received by DOM 302, scheduler 310 holds data packet 141 in actuator 316 for the duration of packet delay time 151 and holds data packet 143 in actuator 316 for the duration of packet delay time 152. This delays data packets 141 and 143. However, scheduler 310 permits data packet 142 to pass to RDT layer 306 without delay, based on the traffic class to which data packet 142 belongs (e.g., less-aggressive non-resync I/Os).

FIG. 4 illustrates a plurality of traffic classes 400 as examples of data traffic that may occur within architecture 100. In some examples, there are two primary traffic classes: resync I/Os 401 (first traffic class) and non-resync I/Os 402 (second traffic class). Non-resync I/Os 402 has three sub-classes: VM I/Os 402a (guest I/Os), namespace I/Os 402b, and metadata I/Os 402c. In some scenarios, resync I/Os 401 grabs bandwidth more aggressively than non-resync I/Os 402 and is the only traffic class that is throttled (e.g., subject to packet delays). In some examples, one or more of the subclasses of non-resync I/Os 402 is also throttled. Scheduler 310 also receives congestion signals 410, such as indications of latency from other hosts and time intervals associated with determining latency. (See FIGS. 6 and 7.)

FIG. 5 illustrates congestion categories 500 that may be used within architecture 100. There are three congestion categories in the illustrated example, although it should be understood that some examples may use a different number of congestion categories. Congestion categories 500 includes a low congestion category 501, a medium congestion category 502, and a high congestion category 503.

In some examples, network congestion conditions are defined according to “net” round trip network latency. In some examples, low congestion category 501 covers network congestion conditions with a net round trip network latency less than 300 microseconds (μs), medium congestion category 502 covers network congestion conditions with a net round trip network latency between 300 μs and 500 ms, and high congestion category 503 covers network congestion conditions with a net round trip network latency greater than 500 ms. In some examples, different latency thresholds are used.

In some examples, one of congestion categories 500 is selected as a target congestion category 504. In the illustrated example, target congestion category 504 is medium congestion category 502, although other examples may use a different network congestion category as the target congestion category. Examples using target congestion category 504 increase and decrease packet delay times in order to keep a corresponding network congestion condition within the range of target congestion category 504.

For example, if network congestion condition 161 falls below target congestion category 504 (e.g., to low congestion category 501), controller 314 (of FIG. 3) will decrease packet delay time 151 to permit higher congestion. Conversely, if network congestion condition 161 rises above target congestion category 504 (e.g., to high congestion category 503), controller 314 will increase packet delay time 151 in an attempt to reduce congestion. This scheme provides a latency-based feedback-control loop that maximizes network resource utilization. Some examples avoid throttling data packets based on other conditions, such as whether bandwidth used by data packets of traffic class resync I/Os 401 have reached a certain threshold. This is explained in further detail in relation to FIG. 8.

Some examples increase throttling when network congestion condition 161 reaches high congestion category 503 using higher steps than are used to decrease throttling when network congestion condition 161 falls to low congestion category 501. For example, if network congestion condition 161 reaches high congestion category 503, packet delay time 151 may be increased in a manner calculated to decrease resync I/O bandwidth by 20% at each redetermination of packet delay time 151 (e.g., on 100 ms intervals). Meanwhile, if network congestion condition 161 drops to low congestion category 501, packet delay time 151 may be decreased in a manner calculated to permit resync I/O bandwidth to increase by 10% at each redetermination of packet delay time 151.

FIG. 6 illustrates an exemplary framework for measurement of network congestion within architecture 100. Host 111 transmits a data packet 641 to host 112 and a data packet 643 to host 113. In some examples, data packets 641 and 643 are normal data traffic, whereas in some examples, data packets 641 and 643 are instead specifically for time measurements. In some examples, a combination of normal data traffic and special timing packets are used to measure latency.

Host 112 returns an acknowledgement 642 to host 111, acknowledging the reception of data packet 641, and host 113 returns an acknowledgement 644 to host 111, acknowledging the reception of data packet 643. Host 111 uses timer 320 to determine a first interval 601 for the time difference between transmitting data packet 641 to host 112 and receiving acknowledgement 642. A similar time interval is determined for the time difference between transmitting data packet 643 to host 113 and receiving acknowledgement 644.

Turning briefly to FIG. 7, a timeline 700 is illustrated, which shows the transmission of data packet 641 from host 111 as a data send event 701. A reception acknowledgement event 702 is shown for when host 111 receives acknowledgement 642. These two events define first interval 601.

Referring now to both FIGS. 6 and 7, host 112 uses a timer 620 to measure a second interval 602 between when host 112 receives data packet 641 from host 111 and when host 112 transmits acknowledgement 642 to host 111. The transmission events may be identified as when an outgoing packet (e.g., data packet 641 or acknowledgement 642) is sent to a host's RDT layer 306 (of FIG. 3), and the reception events may be identified as when an incoming packet is received by a host's RDT layer 306. Host 113 similarly has a timer 623 to measure an interval between when host 113 receives data packet 643 from host 111 and when host 113 transmits acknowledgement 644 to host 111.

Second interval 602 includes processing time at host 112, and so is not part of the transit time through network 102. In some examples, processing time at host 112 includes LSOM processing time. This processing time, reflected by second interval 602, is also included within first interval 601, and needs to be accounted for when determining net round trip transit time 603 through network 102. To permit host 111 to account for second interval 602, host 112 includes an indication of second interval 602 in acknowledgement 642. Host 113 includes similar information in acknowledgement 644.

When host 111 receives acknowledgement 642, sensor 312 determines net round trip transit time 603 through network by subtracting second interval 602 from first interval 601. This is shown in FIG. 6 as an equation and graphically in FIG. 7 as two intervals 703 and 704, with interval 703 being the transit time of data packet 641 from host 111 to host 112 and interval 704 being the transit time of acknowledgement 642 from host 112 to host 111.

In some examples, further calculations are performed to transition from net round trip transit time 603 to latency 322 (of FIG. 3). Some examples perform averaging over time, using a moving window, possibly weighted to emphasize more recent latency measurements. Some examples average latencies from a single host to multiple other hosts. Some examples only measure latency for a subset of the traffic classes (e.g., only those traffic classes that are not throttled, such as non-resync I/Os 402). Some examples combine latency measurements from multiple hosts into an aggregated average. In such examples, various hosts may share their measured and/or calculated latency measurements. In a large cluster, the shared measurements across different hosts may introduce some smoothing effect on the average, due to the uneven workload distribution in the network environment. However, if one or more hosts have a different congestion level than the others, the component side throttling of such hosts provides another chance to correct any inequities. Because the hosts sense their own side congestion globally equally (on the receiver interface), they will automatically apply the correct level of throttling accordingly.

FIG. 8 illustrates a notional graph 800 plotting bandwidth utilization as a function of time. Three bandwidth utilization curves are shown: a resync traffic percentage 801, shown as a dash-dot line, a non-resync traffic percentage 802 shown as a dotted line, and a total traffic percentage 803, shown as a solid line. Additionally, a minimum bandwidth allocation 804 for resync I/Os 401 is shown as a dashed line threshold.

In graph 800, initially, there is no resync traffic (e.g., no traffic of the class resync I/Os 401), so total traffic percentage 803 is all non-resync traffic percentage 802. However, upon the advent of resync traffic percentage 801 becoming non-zero (e.g., traffic of the class resync I/Os 401 appears on network 102), total traffic percentage 803 becomes a sum of resync traffic percentage 801 and non-resync traffic percentage 802.

Total traffic percentage 803 climbs to 100% of its maximum, so non-resync traffic percentage 802 drops as resync traffic percentage 801 climbs. When resync traffic percentage 801 exceeds minimum bandwidth allocation 804, traffic of the class resync I/Os 401 becomes subject to throttling. In some examples, throttling does not occur when resync traffic percentage 801 is below minimum bandwidth allocation 804. In some examples, minimum bandwidth allocation 804 is 20% of the total traffic capacity of network 102. This leaves 80% of the total traffic capacity of network 102 for traffic of the class non-resync I/Os 402. In some examples, minimum bandwidth allocation 804 is 15% to 25% of the total traffic capacity of network 102. In some examples, minimum bandwidth allocation 804 applies on a per-host basis, and is enforced for both transmission and reception.

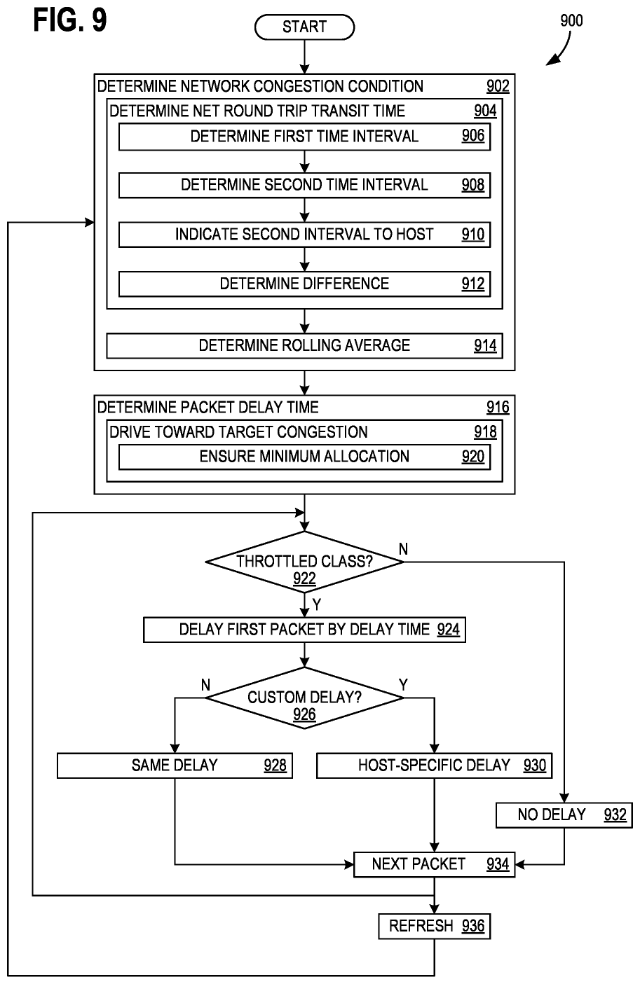

FIG. 9 illustrates a flowchart 900 of exemplary operations that may be performed by examples of architecture 100. In some examples, the operations of flowchart 900 are performed by one or more computing apparatus 1118 of FIG. 11. Flowchart 900 is performed in a distributed fashion, such as for each of multiple hosts in architecture 100. In the description of flowchart 900, the first traffic class refers to resync I/Os 401 and the second traffic class refers to non-resync traffic I/Os 402. Flowchart 900 commences with determining network congestion condition 161 and/or network congestion condition 162 at host 111 in operation 902. Network congestion condition 161 is between host 111 and host 112, and network congestion condition 162 is between host 111 and host 113. In some examples, network congestion conditions are determined for only a subset of plurality of traffic classes 400, such as only for the second traffic class.

Determining network congestion conditions uses operations 904-914. Operation 904 determines net round trip transit time 603 from host 111, through network 102, to host 112, and also determines a net round trip transit time from host 111, through network 102, to host 113. Operation 904 is performed using operations 906-912. Operation 906 determines first time interval 601 starting upon data send event 701 from host 111 and ending upon receiving acknowledgement 624 at host 111 from host 112 (e.g., reception acknowledgement event 702). Operation 908 determines second time interval 602, which comprises processing time at host 112. Operation 910 indicates second time interval 602 to host 111 (e.g., using acknowledgement 642), and operation 912 determines a difference between first time interval 601 and second time interval 602.

Operation 914 determines a rolling average of net round trip transit times. In some examples, the rolling average of net round trip transit times is weighted more heavily for more recent net round trip transit times, and in some examples, the rolling average of net round trip transit times includes net round trip transit times determined by a plurality of hosts.

Operation 916 determines packet delay times based on at least network congestion condition, such as determining packet delay time 151 based on at least network congestion condition 161, and determining packet delay time 152 based on at least network congestion condition 162. Operation 916 is performed using operations 918 and 920. Operation 918 selects packet delay times to drive a corresponding network congestion condition toward target congestion category 504, such as selecting packet delay time 151 to drive network congestion condition 161 toward target congestion category 504 and selecting packet delay time 152 to drive network congestion condition 162 toward target congestion category 504.

In some examples, operation 920 acts as an exception to operation 918 and reduces a delay of a data packet belonging to the first traffic class to ensure minimum bandwidth allocation 804 for the first traffic class. In some examples, minimum bandwidth allocation 804 is within a range of 15 percent to 25 percent.

Decision operation 922 determines whether a data packet is within a traffic class that is subject to throttling (e.g., delay), for example resync I/Os 401. If so, which is the case for data packet 141, operation 924 delays transmitting data packet 141, from host 111 across network 102 to host 112, by packet delay time 151 based on at least data packet 141 belonging to the first traffic class of plurality of traffic classes 400. In some examples, DOM 302 determines network congestion conditions and delays transmitting data packets. Some examples delay only payload traffic, whereas some examples delay both payload traffic and non-payload traffic. Some examples delay only write traffic, whereas some examples delay both read traffic and write traffic.

Decision operation 926 determines whether packet delays are custom to different hosts. If not, operation 928 delays transmitting data packet 143, from host 111 across network 102 to host 113, by packet delay time 151 based on at least data packet 143 belonging to the first traffic class. Otherwise, if delays are custom to different hosts, operation 930 delays transmitting data packet 143, from host 111 across network 102 to host 113, by packet delay time 152 based on at least data packet 143 belonging to the first traffic class.

If, back at decision operation 922, a data packet is not within a traffic class that is subject to throttling, which is the case for data packet 142, operation 932 transmits data packet 142 from host 111 to host 112 without delay, based on at least data packet 142 belonging to the second traffic class of plurality of traffic classes 400.

At box 934, flowchart 900 returns to decision operation 922 for the next outgoing packet from host 111, and at box 936, flowchart 900 returns to operation 902 on the network congestion refresh interval (e.g., 100 ms).

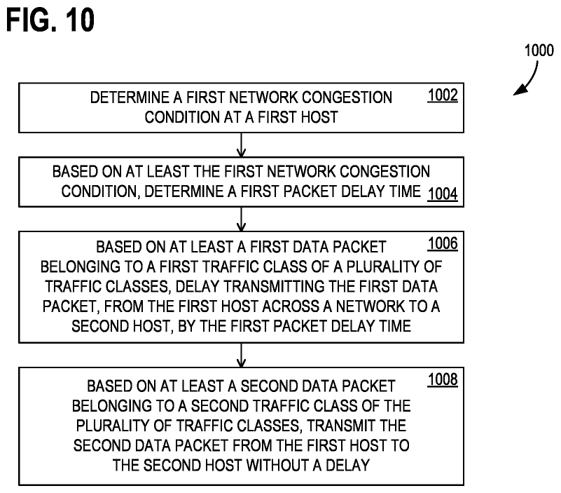

FIG. 10 illustrates a flowchart 1000 of exemplary operations associated with architecture 100. In some examples, the operations of flowchart 1000 are performed by one or more computing apparatus 1118 of FIG. 11. Flowchart 1000 commences with operation 1002, which includes determining a first network congestion condition at a first host.

Operation 1004 includes, based on at least the first network congestion condition, determining a first packet delay time. Operation 1006 includes, based on at least a first data packet belonging to a first traffic class of a plurality of traffic classes, delaying transmitting the first data packet, from the first host across a network to a second host, by the first packet delay time. Operation 1008 includes, based on at least a second data packet belonging to a second traffic class of the plurality of traffic classes, transmitting the second data packet from the first host to the second host without a delay (e.g., not delaying transmitting the second data packet from the first host to the second host).

### Additional Examples

An example method comprises: determining a first network congestion condition at a first host; based on at least the first network congestion condition, determining a first packet delay time; based on at least a first data packet belonging to a first traffic class of a plurality of traffic classes, delaying transmitting the first data packet, from the first host across a network to a second host, by the first packet delay time; and based on at least a second data packet belonging to a second traffic class of the plurality of traffic classes, transmitting the second data packet from the first host to the second host without a delay.

An example computer system comprises: a sensor determining a first network congestion condition at a first host; scheduler determining a first packet delay time based on at least the first network congestion condition; the scheduler delaying transmitting the first data packet, from the first host across a network to a second host, by the first packet delay time, based on at least a first data packet belonging to a first traffic class of a plurality of traffic classes; and a transmitter transmitting the second data packet from the first host to the second host without a delay from the scheduler, based on at least a second data packet belonging to a second traffic class of the plurality of traffic classes.

Another example computer system comprises: a processor; and a non-transitory computer readable medium having stored thereon program code executable by the processor, the program code causing the processor to: determine a first network congestion condition at a first host; based on at least the first network congestion condition, determine a first packet delay time; based on at least a first data packet belonging to a first traffic class of a plurality of traffic classes, delay transmitting the first data packet, from the first host across a network to a second host, by the first packet delay time; and based on at least a second data packet belonging to a second traffic class of the plurality of traffic classes, transmit the second data packet from the first host to the second host without a delay.

An example non-transitory computer storage medium has stored thereon program code executable by a processor, the program code embodying a method comprising: determining a first network congestion condition at a first host; based on at least the first network congestion condition, determining a first packet delay time; based on at least a first data packet belonging to a first traffic class of a plurality of traffic classes, delaying transmitting the first data packet, from the first host across a network to a second host, by the first packet delay time; and based on at least a second data packet belonging to a second traffic class of the plurality of traffic classes, transmitting the second data packet from the first host to the second host without a delay.

Alternatively, or in addition to the other examples described herein, examples include any combination of the following:
based on at least a third data packet belonging to the first traffic class, delaying transmitting the third data packet, from the first host across the network to a third host, by the first packet delay time;
determining a second network congestion condition at the first host;
the first network congestion condition is between the first host and the second host;
the second network congestion condition is between the first host and a third host;
based on at least the second network congestion condition, determining a second packet delay time;
based on at least a third data packet belonging to the first traffic class, delaying transmitting the third data packet, from the first host across the network to the third host, by the second packet delay time;
the first traffic class comprises resync I/Os and the second traffic class comprises non-resync traffic I/Os;
determining the first packet delay time comprises selecting the first packet delay time to drive the network congestion condition toward a target congestion category;
reducing a delay of a data packet belonging to the first traffic class to ensure a minimum bandwidth allocation for the first traffic class;
determining the first network congestion condition comprises determining a net round trip transit time through the network for the second traffic class;
the network congestion condition comprises a congestion category of a set of two or more congestion categories;
the network congestion condition comprises a congestion category of a set of three congestion categories;
determining the second packet delay time comprises selecting the second packet delay time to drive the network congestion condition toward a target congestion category;
determining the first network congestion condition comprises determining a net round trip transit time, from the first host through the network to the second host;
determining the second network congestion condition comprises determining a net round trip transit time, from the first host through the network to the third host;
determining the second network congestion condition comprises determining a net round trip transit time through the network for the second traffic class;
determining the first network congestion condition comprises determining a rolling average of net round trip transit times;
determining the second network congestion condition comprises determining a rolling average of net round trip transit times;
the rolling average of net round trip transit times is weighted more heavily for more recent net round trip transit times;
the rolling average of net round trip transit times includes net round trip transit times determined by a plurality of hosts;
determining the net round trip transit time through the network comprises determining a first time interval starting upon a data send event from the first host and ending upon receiving an acknowledgement at the first host from the second host;
determining the net round trip transit time through the network further comprises determining a second time interval comprising processing time at the second host;
determining the net round trip transit time through the network further comprises indicating the second time interval to the first host;
determining the net round trip transit time through the network further comprises determining a difference between the first time interval and the second time interval;
the data send event comprises moving an outgoing packet to an RDT layer;
the processing time comprises LSOM processing time;
the plurality of traffic classes comprises resync I/Os, guest I/Os, namespace I/Os, and metadata I/Os;
each of the guest I/Os, the namespace I/Os, and the metadata I/Os is non-resync traffic;
delaying only payload traffic;
delaying both payload traffic and non-payload traffic;
delaying only write traffic;
delaying both read and write traffic;
the scheduler delays transmitting the third data packet, from the first host across the network to a third host, by the first packet delay time, based on at least a third data packet belonging to the first traffic class;
the sensor determines a second network congestion condition at the first host, wherein the first network congestion condition is between the first host and the second host, and wherein the second network congestion condition is between the first host and a third host;
the scheduler determines a second packet delay time based on at least the second network congestion condition;
wherein the scheduler delays transmitting the third data packet, from the first host across the network to the third host, by the second packet delay time, based on at least a third data packet belonging to the first traffic class;
the scheduler reduces a delay of a data packet belonging to the first traffic class to ensure a minimum bandwidth allocation for the first traffic class;
the minimum bandwidth allocation for the first traffic class is within a range of 15 percent to 25 percent; and
a DOM determines the first network congestion condition and delays transmitting the first data packet.

### Exemplary Operating Environment

The present disclosure is operable with a computing device (computing apparatus) according to an embodiment shown as a functional block diagram 1100 in FIG. 11. In an embodiment, components of a computing apparatus 1118 may be implemented as part of an electronic device according to one or more embodiments described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hardcoded machine. Platform software comprising an operating system 1120 or any other suitable platform software may be provided on the computing apparatus 1118 to enable application software 1121 (program code) to be executed by one or more processors 1119. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1118. Non-transitory computer-readable media may include, for example, computer storage media such as a memory 1122 and communications media. Computer storage media, such as a memory 1122, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1122) is shown within the computing apparatus 1118, it will be appreciated by a person skilled in the art, that the storage may be distributed or located remotely and accessed via a network or other communication link (e.g. using a communication interface 1123). Computer storage media are tangible, non-transitory, and are mutually exclusive to communication media.

The computing apparatus 1118 may comprise an input/output controller 1124 configured to output information to one or more output devices 1125, for example a display or a speaker, which may be separate from or integral to the electronic device. The input/output controller 1124 may also be configured to receive and process an input from one or more input devices 1126, for example, a keyboard, a microphone, or a touchpad. In one embodiment, the output device 1125 may also act as the input device. An example of such a device may be a touch sensitive display. The input/output controller 1124 may also output data to devices other than the output device, e.g. a locally connected printing device. In some embodiments, a user may provide input to the input device(s) 1126 and/or receive output from the output device(s) 1125.

The functionality described herein can be performed, at least in part, by one or more hardware logic components. According to an embodiment, the computing apparatus 1118 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided, such as via a dialog box or preference setting, to the users of the collection of the data (e.g., the operational metadata) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method comprising:
determining a first network congestion condition at a first host;
based on at least the first network congestion condition, determining a first packet delay time;
based on at least a first data packet belonging to a first traffic class of a plurality of traffic classes, delaying transmitting the first data packet, from the first host across a network to a second host, by the first packet delay time; and
based on at least a second data packet belonging to a second traffic class of the plurality of traffic classes, transmitting the second data packet from the first host to the second host without a delay.

2. The computerized method of claim 1, further comprising:
based on at least a third data packet belonging to the first traffic class, delaying transmitting the third data packet, from the first host across the network to a third host, by the first packet delay time.

3. The computerized method of claim 1, further comprising:
determining a second network congestion condition at the first host, wherein the first network congestion condition is between the first host and the second host, and wherein the second network congestion condition is between the first host and a third host;
based on at least the second network congestion condition, determining a second packet delay time; and
based on at least a third data packet belonging to the first traffic class, delaying transmitting the third data packet, from the first host across the network to the third host, by the second packet delay time.

4. The computerized method of claim 1, wherein the first traffic class comprises resync input/output operations (I/Os) and the second traffic class comprises non-resync traffic I/Os.

5. The computerized method of claim 1, wherein determining the first packet delay time comprises:
selecting the first packet delay time to drive the network congestion condition toward a target congestion category.

6. The computerized method of claim 1, further comprising:
reducing a delay of a data packet belonging to the first traffic class to ensure a minimum bandwidth allocation for the first traffic class.

7. The computerized method of claim 1, wherein determining the first network congestion condition comprises:
determining a net round trip transit time through the network for the second traffic class.

8. A computer system comprising:
a sensor configured to determine a first network congestion condition at a first host;
a scheduler configured to determine a first packet delay time based on at least the first network congestion condition;
the scheduler further configured to delay transmitting the first data packet, from the first host across a network to a second host, by the first packet delay time, based on at least a first data packet belonging to a first traffic class of a plurality of traffic classes; and
a transmitter configured to transmit the second data packet from the first host to the second host without a delay from the scheduler, based on at least a second data packet belonging to a second traffic class of the plurality of traffic classes.

9. The computer system of claim 8, wherein the scheduler is configured to delay transmitting the third data packet, from the first host across the network to a third host, by the first packet delay time, based on at least a third data packet belonging to the first traffic class.

10. The computer system of claim 8,
wherein the sensor is further configured to determine a second network congestion condition at the first host, wherein the first network congestion condition is between the first host and the second host, and wherein the second network congestion condition is between the first host and a third host;
wherein the scheduler is further configured to determine a second packet delay time based on at least the second network congestion condition; and
wherein the scheduler is further configured to delay transmitting the third data packet, from the first host across the network to the third host, by the second packet delay time, based on at least a third data packet belonging to the first traffic class.

11. The computer system of claim 8, wherein the first traffic class comprises resync input/output operations (I/Os) and the second traffic class comprises non-resync traffic I/Os.

12. The computer system of claim 8, wherein determining the first packet delay time comprises:
selecting the first packet delay time to drive the network congestion condition toward a target congestion category.

13. The computer system of claim 8, wherein the scheduler is configured to reduce a delay of a data packet belonging to the first traffic class to ensure a minimum bandwidth allocation for the first traffic class.

14. The computer system of claim 8, wherein determining the first network congestion condition comprises:
determining a net round trip transit time through the network for the second traffic class.

15. A non-transitory computer storage medium having stored thereon program code executable by a processor, the program code embodying a method comprising:
determining a first network congestion condition at a first host;
based on at least the first network congestion condition, determining a first packet delay time;
based on at least a first data packet belonging to a first traffic class of a plurality of traffic classes, delaying transmitting the first data packet, from the first host across a network to a second host, by the first packet delay time; and
based on at least a second data packet belonging to a second traffic class of the plurality of traffic classes, transmitting the second data packet from the first host to the second host without a delay.

16. The computer storage medium of claim 15, wherein the program code method further comprises:
based on at least a third data packet belonging to the first traffic class, delaying transmitting the third data packet, from the first host across the network to a third host, by the first packet delay time.

17. The computer storage medium of claim 15, wherein the program code method further comprises:
determining a second network congestion condition at the first host, wherein the first network congestion condition is between the first host and the second host, and wherein the second network congestion condition is between the first host and a third host;
based on at least the second network congestion condition, determining a second packet delay time; and
based on at least a third data packet belonging to the first traffic class, delaying transmitting the third data packet, from the first host across the network to the third host, by the second packet delay time.

18. The computer storage medium of claim 15, wherein the first traffic class comprises resync input/output operations (I/Os) and the second traffic class comprises non-resync traffic I/Os.

19. The computer storage medium of claim 15, wherein determining the first packet delay time comprises:
selecting the first packet delay time to drive the network congestion condition toward a target congestion category.

20. The computer storage medium of claim 15, wherein the program code method further comprises:
reducing a delay of a data packet belonging to the first traffic class to ensure a minimum bandwidth allocation for the first traffic class.
